(19) United States
(12) Patent Application Publication
(10) Pub. No.: US 2018/0061413 A1
(43) Pub. Date: Mar. 1, 2018

(54) ELECTRONIC DEVICE, CONTROL METHOD, AND COMPUTER CODE

(71) Applicant: KYOCERA Corporation, Kyoto-shi (JP)

(72) Inventors: Shigeki TANABE, Yokohama-shi (JP); Hideki MORITA, Yokohama-shi (JP); Isao MASUIKE, Tokyo (JP); Shinya SAITO, Kawasaki-shi (JP)

(21) Appl. No.: 15/690,432

(22) Filed: Aug. 30, 2017

(30) Foreign Application Priority Data
Aug. 31, 2016 (JP) 2016-168859

(51) Int. Cl. G10L 15/22; G06F 3/16

(52) U.S. Cl. CPC G10L 15/22; G10L 2015/228; G10L 2015/223; G06F 3/167

(57) ABSTRACT

An electronic device includes a voice input unit, and a controller configured to execute a voice input mode in which a process according to a voice command input to the voice input unit is performed. The controller is configured to determine whether the electronic device is moving, and execute the voice input mode when determining that the electronic device is moving.

### CROSS-REFERENCE TO RELATED APPLICATION(S)

The present application claims priority under 35 U.S.C. §119 to Japanese Patent Application No. 2016-168859 filed on Aug. 31, 2016, entitled “ELECTRONIC DEVICE, CONTROL METHOD, AND COMPUTER CODE”. The content of which is incorporated by reference herein in its entirety.

### FIELD

The present application relates to an electronic device that can detect movement of the electronic device.

### BACKGROUND

Conventionally, there is a mobile electronic device that includes a display for displaying information and a controller for determining a moving state of the mobile electronic device, and the controller determines information to be displayed on the display when the display is turned on, on the basis of the moving state of the mobile electronic device. The mobile electronic device also includes a touch screen that is to be displayed on the display in an overlapping manner and that detects contact of a finger for operating the mobile electronic device.

### SUMMARY

An electronic device according to one aspect includes a voice input unit, and a controller configured to execute a voice input mode in which a process according to a voice command input to the voice input unit is performed. The controller is configured to determine whether the electronic device is being moved, and execute the voice input mode when determining that the electronic device is being moved.

Further, a control method according to one aspect is the control method of an electronic device that includes a voice input unit and a controller. The controller is capable of executing a voice input mode in which a process is performed according to a voice command input to the voice input unit. The control method includes steps of determining whether the electronic device is being moved, and executing the voice input mode when determining that the electronic device is being moved.

Further, a non-transitory computer readable recording medium according to one aspect stores thereon a control code. An electronic device includes a voice input unit and a controller. The controller is capable of executing a voice input mode for performing a process according to a voice command input to the voice input unit. The control code causes the electronic device to execute steps of determining whether the electronic device is being moved, and executing the voice input mode when determining that the electronic device is being moved.

### BRIEF DESCRIPTION OF THE DRAWINGS

FIG. 1 is an external view of a mobile phone according to a first embodiment;

FIG. 2 is a block diagram of the mobile phone according to the first embodiment;

FIG. 3 is a flow chart illustrating a first example of control performed by the mobile phone according to the first embodiment;

FIG. 4 is a flow chart illustrating a second example of control performed by the mobile phone according to the first embodiment; and

FIG. 5 is a block diagram of a mobile phone according to a second embodiment.

### DETAILED DESCRIPTION

Hereinafter, embodiments according to the present application will be described in detail with reference to the accompanying drawings. However, the present application is not limited to the following embodiments. It is to be understood that components in the following explanation include components that can be easily assumed by a person skilled in the art, components that are substantially the same, and components that fall within what is called a range of equivalents. In the drawings, the same reference numerals denote the same components, and their repeated description will be omitted. In the following, a mobile phone is described as an example of an electronic device. However, the embodiments are not limited thereto, and the electronic device may also be one of various devices such as an on-vehicle electronic device, a tablet, and a personal computer. Operating a touch screen of an electronic device while a user is moving may be dangerous for the user. An object of the present application is to provide an electronic device for the user not to encounter danger.

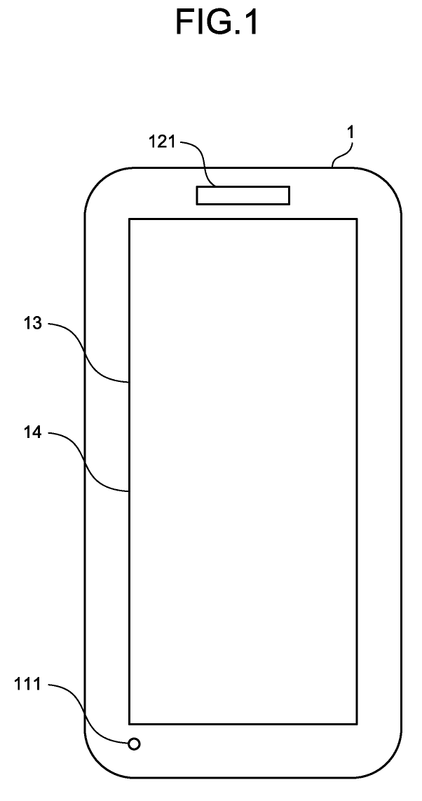

A first embodiment of an electronic device according to the present application will now be described. FIG. 1 is an external view of a mobile phone 1 according to the first embodiment. As illustrated in FIG. 1, the mobile phone 1 includes a microphone 111, a speaker 121, a touch panel 13, and a display 14.

The microphone 111 is one of input units and receives input to the mobile phone 1. The microphone 111 collects the surrounding voice.

The speaker 121 is one of output units and allows output from the mobile phone 1. Voice from a telephone, and/or information on various computer codes are output from the speaker 121 in the form of voice.

The touch panel 13 is one of input units and receives input to the mobile phone 1. The touch panel 13 detects contact of user's finger, a stylus, and the like. For example, a method of detecting contact includes a resistive film method, an electrostatic capacitance method, and the like. However, the method of detecting contact may be any desired method.

The display 14 is one of output units and allows output from the mobile phone 1. The display 14 displays objects such as characters, images, symbols, and diagrams on a screen. For example, the display 14 includes a liquid crystal display, an organic electroluminescence (EL) display, and the like. In FIG. 1, the display 14 and the touch panel 13 are provided in an overlapping manner, and the display area of the display 14 overlaps with the touch panel 13. However, the present embodiments are not limited thereto. For example, the display 14 and the touch panel 13 may be disposed side by side, or may be disposed separate from each other. When the display 14 and the touch panel 13 overlap with each other, one or a plurality of sides of the display 14 need not to be arranged along any of the sides of the touch panel 13.

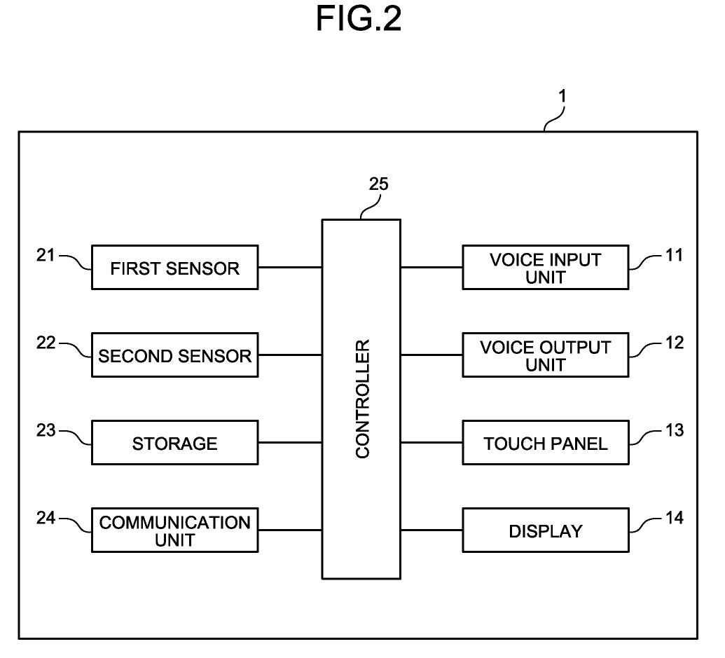

A functional configuration of the mobile phone 1 will now be described with reference to FIG. 2. FIG. 2 is a block diagram illustrating a functional configuration of the mobile phone 1. As illustrated in FIG. 2, the mobile phone 1 includes a voice input unit 11, a voice output unit 12, the touch panel 13, the display 14, a first sensor 21, a second sensor 22, storage 23, a communication unit 24, and a controller 25.

The voice input unit 11 is a unit that can receive voice input. The voice input unit 11 includes the microphone 111 described above. The voice input unit 11 may also be an input interface that can be connected to an external microphone. The external microphone is wirelessly or wiredly connected to the voice input unit 11. For example, the microphone to be connected to the input interface is a microphone provided on an earphone or the like that can be connected to the mobile phone 1. The voice input unit 11 can collect voice and transmit a signal corresponding to the voice the input of which is received, to the controller 25.

The voice output unit 12 is a unit that can output voice. The voice output unit 12 includes the speaker 121 described above. The voice output unit 12 may also be an output interface that can be connected to an external speaker. The external speaker is wirelessly or wiredly connected to the voice output unit 12. For example, the speaker to be connected to the output interface is a speaker provided on the earphone or the like that can be connected to the mobile phone 1. The voice output unit 12 can output voice on the basis of a signal supplied from the controller 25.

The touch panel 13 detects contact of a finger, and supplies a signal corresponding to an operation performed by the detected finger, to the controller 25.

The display 14 displays objects such as characters, images, symbols, and diagrams on the screen, on the basis of a signal supplied from the controller 25.

The first sensor 21 at least includes an acceleration sensor. The first sensor 21 may also include a gyro sensor, a direction sensor, and the like. The acceleration sensor detects the direction and amount of acceleration applied to the mobile phone 1. The gyro sensor detects the angle and angle speed of the mobile phone 1. The direction sensor detects the orientation of the terrestrial magnetism. The first sensor 21 supplies the detection result to the controller 25.

The second sensor 22 detects the surrounding state of the mobile phone 1. For example, the second sensor 22 is a proximity sensor, an illumination sensor, or the like. The proximity sensor detects the presence of an object in the vicinity in a contactless manner, on the basis of the change in the magnetic field, the change in returning time of reflected waves of ultrasonic waves, or the like. The illumination sensor detects the amount of light incident on a light receiving element. The second sensor 22 supplies the detection result to the controller 25. The second sensor 22 is not limited to the proximity sensor or the illumination sensor, and may be any sensor as long as the sensor can detect the surrounding state of the mobile phone 1.

The storage 23 stores therein computer codes and data. The storage 23 is also used as a work area for temporarily storing the processing results of the controller 25. The storage 23 may include a semiconductor storage medium and any non-transitory storage medium such as a magnetic storage medium. The storage 23 may include a plurality of types of storage mediums. The storage 23 may include a combination of a portable storage medium such as a memory card, an optical disc, or an optical magnetic disc with a reading device of the storage medium. The storage 23 may include a storage device used as a temporary storage area such as a random access memory (RAM). The computer codes to be stored in the storage 23 include applications executed in the foreground or background, as well as a control code that supports the operation of the applications.

The communication unit 24 communicates wirelessly. For example, wireless communication standards supported by the communication unit 24 include communication standards for cellular phones such as 2G, 3G, and 4G, communication standards for short-range wireless communication, and the like. For example, the communication standards for the short-range wireless communication include Institute of Electrical and Electronics Engineers (IEEE) 802.11, Bluetooth (registered trademark), Infrared Data Association (IrDA), near field communication (NFC), wireless personal area network (WPAN), and the like. For example, the communication standards for the WPAN include ZigBee (registered trademark).

The controller 25 is an operation processing device. For example, the operation processing device includes a central processing unit (CPU), a system-on-a-chip (SoC), a micro control unit (MCU), a field-programmable gate array (FPGA), and a coprocessor. However, the operation processing device is not limited thereto. The controller 25 can implement various functions by integrally controlling the operation of the mobile phone 1.

The controller 25 can determine whether the mobile phone 1 is being moved, on the basis of the detection result of the first sensor 21. The controller 25 determines how the mobile phone 1 is being moved on the basis of the detection result of the first sensor 21. For example, the mobile phone 1 is being moved when a user is moving (such as walking), when a vehicle such as a railway train or an automobile is moving, and the like. The controller 25 may determine whether the mobile phone 1 is being moved or determine how the mobile phone 1 is being moved, only on the basis of the detection result of the acceleration sensor that is the first sensor 21. The controller 25 may also determine whether the mobile phone 1 is being moved or determine how the mobile phone 1 is being moved, by combining the detection result of the gyro sensor or the direction sensor with the detection result of the acceleration sensor.

The controller 25 can determine whether a user is moving with the mobile phone 1 being held in his/her hand, on the basis of the detection results of the first sensor 21 and the second sensor 22. For example, when it is determined that the mobile phone 1 is being moved from the detection result of the first sensor 21, and that the mobile phone 1 is out of a user's bag, a pocket of the user's clothes, or the like from the detection result of the second sensor 22, the controller 25 can determine that the user is moving with the mobile phone 1 being held in his/her hand. For example, when the second sensor 22 is the proximity sensor, the controller 25 may determine whether the mobile phone 1 is in the user's bag or in the pocket of user's clothes, depending on whether the proximity sensor detects the presence of an object in the vicinity. When the second sensor is the illumination sensor, the controller 25 may determine whether the mobile phone 1 is in the user's bag or in the pocket of the user's clothes, depending on the amount of light detected by the illumination sensor.

The controller 25 can perform various controls on the basis of voice input to the voice input unit 11 and/or a signal that is input according to the contact operation and the like detected by the touch panel 13. The controller 25 can perform output corresponding to the input signal through the speaker 121, the display 14, or the like, as the various controls. The controller 25 can also execute the functions of the mobile phone 1 and change the settings, as the various controls.

The controller 25 can recognize an instruction indicated by the user's voice (voice recognition), by analyzing the voice input to the voice input unit 11. The controller 25 can then perform various controls according to the instruction (voice command) indicated by the recognized voice.

When it is determined that the mobile phone 1 is being moved, the controller 25 can execute a voice input mode. The voice input mode is a mode in which a process according to the voice command input to the voice input unit 11 is performed. In the voice input mode, the controller 25 can start voice recognition after voice that triggers the voice input mode (voice trigger) is input to the voice input unit 11. The controller 25 can continuously execute the voice input mode while the controller 25 can determine that the mobile phone 1 is being moved.

In this manner, the user can operate the mobile phone 1 without carefully watching the screen while the user is moving. Consequently, it is possible to prevent the user from encountering danger.

In the voice input mode, the controller 25 need not request for the voice trigger. In other words, the controller 25 may always receive voice input and perform voice recognition on the received voice.

As described above, the controller 25 can specify how the user is moving. When it is determined that the mobile phone 1 is being moved, the controller 25 may execute the voice input mode only when the mobile phone 1 is being moved in a specific manner. For example, when it is determined that the mobile phone 1 is being moved, the controller 25 may execute the voice input mode when the mobile phone 1 is being moved as a result of the user walking (particular moving). For example, in the case when it is determined that the mobile phone 1 is being moved, the controller 25 need not execute the voice input mode when it is determined that the mobile phone 1 is being moved as a result of the train moving.

In the voice input mode, the controller 25 may output voice in response to the voice, as a process corresponding to the input voice command. In this manner, it is possible to further prevent the user from carefully watching the screen.

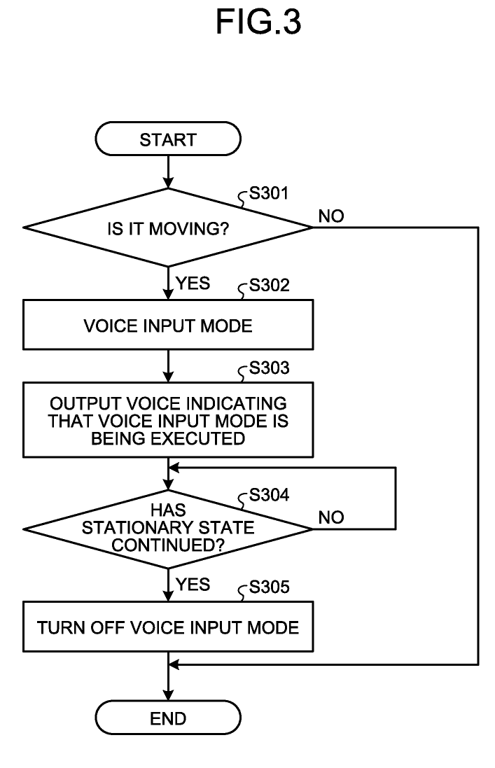

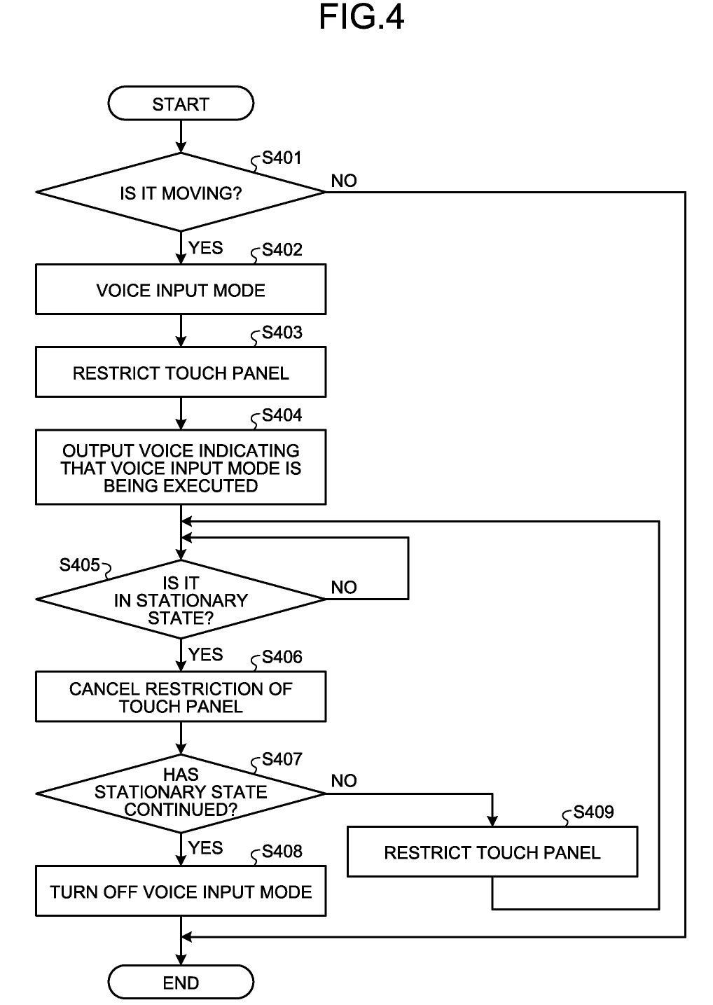

Processing flows to be executed by the mobile phone 1 configured as above will now be described with reference to FIG. 3 and FIG. 4.

FIG. 3 is a flow chart illustrating a first example of control performed by the mobile phone according to the first embodiment.

The controller 25 can determine whether the mobile phone 1 is being moved (Step S301). When it is determined that the mobile phone 1 is not being moved (No at Step S301), the controller 25 can finish the process. When it is determined that the mobile phone 1 is being moved (Yes at Step S301), the controller 25 can execute the voice input mode described above (Step S302).

When starting execution of the voice input mode, the controller 25 can output a voice indicating that the voice input mode is being executed through the speaker 121 (Step S303).

The controller 25 can determine whether a stationary state of the mobile phone 1 has continued for a predetermined period of time after the mobile phone 1 has become stationary, while the voice input mode is being executed (Step S304). When it is determined that a predetermined period of time has not passed after the mobile phone 1 has become stationary, in other words, when it is determined that the mobile phone 1 is moved once again before a predetermined period of time has passed after the mobile phone 1 has become stationary (No at Step S304), the controller 25 can repeat the process at Step S304. When it is determined that a predetermined period of time has passed after the mobile phone 1 has become stationary (Yes at Step S304), the controller 25 can stop executing the voice input mode (Step S305), and finish the process. The predetermined period of time may be several tens of seconds or few minutes. However, the embodiments are not limited thereto.

As illustrated in FIG. 3, the mobile phone 1 notifies the user that the voice input mode is being executed. Consequently, the user can easily recognize that the voice input mode is being executed.

As illustrated in FIG. 3, the execution of the voice input mode is stopped after a predetermined period of time has passed after the mobile phone 1 has become stationary. Consequently, it is possible to reduce a possibility that the voice input mode is cancelled unnecessarily.

The process of “determining whether the mobile phone 1 is being moved” at Step S301 in FIG. 3 may also be a process of “determining whether the mobile phone 1 is being moved as well as determining whether a predetermined operation is performed on the touch panel 13”. When it is detected that the mobile phone 1 is being moved and that a predetermined operation is performed on the touch panel 13, the controller 25 can execute the voice input mode. Consequently, it is possible to reduce a possibility that the voice input mode is executed unnecessarily. The predetermined operation may be all the operations of touching the touch panel, or may be a specific touch panel operation for executing various functions.

The process of “determining whether the mobile phone 1 is being moved” at Step S301 in FIG. 3 may also be a process of “determining whether the mobile phone 1 is being moved as well as determining whether the user is holding the mobile phone 1 in his/her hand”. When it is determined that the mobile phone 1 is being moved and that the user is holding the mobile phone in his/her hand, the controller 25 can execute the voice input mode. Consequently, it is possible to reduce a possibility that the voice input mode is executed unnecessarily. In this configuration, the process of “determining whether a stationary state of the mobile phone 1 has continued for a predetermined period of time after the mobile phone 1 has become stationary while the voice input mode is being executed” at Step S304 in FIG. 3 may also be a process of “determining whether a stationary state of the mobile phone 1 has continued for a predetermined period of time after the mobile phone 1 has become stationary while the voice input mode is being executed, or determining whether the mobile phone 1 is being moved but the user is not holding the mobile phone 1 in his/her hand”. When it is determined that the stationary state of the mobile phone 1 has continued for a predetermined period of time after the mobile phone 1 has become stationary, or that the mobile phone 1 is being moved, but the user is not holding the mobile phone 1 in his/her hand, the controller 25 can finish executing the voice input mode.

The process of “determining whether the mobile phone 1 is being moved” at Step S301 in FIG. 3 may also be a process of “determining whether the mobile phone 1 is being moved as well as determining whether a predetermined application is activated”. When it is determined that the mobile phone 1 is being moved and that a predetermined application is activated, the controller 25 can execute the voice input mode. Consequently, it is possible to reduce a possibility that the voice input mode is executed unnecessarily. The predetermined application may also be activated by the voice command upon detecting the voice trigger. In this configuration, the process of “determining whether a stationary state of the mobile phone 1 has continued for a predetermined period of time after the mobile phone 1 has become stationary while the voice input mode is being executed” at step S304 in FIG. 3 may also be a process of “determining whether a stationary state of the mobile phone 1 has continued for a predetermined period of time after the mobile phone 1 has become stationary while the voice input mode is being executed, or determining whether execution of a predetermined application is finished”. When it is determined that the stationary state of the mobile phone 1 has continued for a predetermined period of time after the mobile phone 1 has become stationary, or that the execution of a predetermined application is finished, the controller 25 can finish executing the voice input mode.

The process of “determining whether the mobile phone 1 is being moved” at Step S301 in FIG. 3 may also be a process of “determining whether the mobile phone 1 is being moved as well as determining whether a predetermined function of a predetermined application is being executed”. When it is determined that the mobile phone 1 is being moved and that a predetermined function of a predetermined application is being executed, the controller 25 can execute the voice input mode. Consequently, it is possible to reduce a possibility that the voice input mode is executed unnecessarily. In this configuration, the process of “determining whether a stationary state of the mobile phone 1 has continued for a predetermined period of time after the mobile phone 1 has become stationary while the voice input mode is being executed” at Step S304 in FIG. 3 may also be a process of “determining whether a stationary state of the mobile phone 1 has continued for a predetermined period of time after the mobile phone 1 has become stationary while the voice input mode is being executed, or determining whether execution of a predetermined function of a predetermined application is finished”. When it is determined that the stationary state of the mobile phone 1 has continued for a predetermined period of time after the mobile phone 1 has become stationary, or that the execution of a predetermined function of a predetermined application is finished, the controller 25 can finish executing the voice input mode.

FIG. 4 is a flow chart illustrating a second example of control performed by the mobile phone according to the first embodiment.

The controller 25 can determine whether the mobile phone 1 is being moved (Step S401). When it is determined that the mobile phone 1 is not being moved (No at Step S401), the controller 25 can finish the process. When it is determined that the mobile phone 1 is being moved (Yes at Step S401), the controller 25 can execute the voice input mode (Step S402).

When starting execution of the voice input mode, the controller 25 can set restriction on at least a part of execution of the functions of the mobile phone 1 that are obtained by operating the touch panel 13 (Step S403). For example, the restriction may be a restriction of not allowing the touch panel 13 to detect contact. The restriction may also be a restriction of not allowing the controller 25 to perform output process corresponding to the signal supplied to the controller 25 by the touch panel operation.

The controller 25 can output a voice indicating that the voice input mode is being executed through the speaker 121 after setting restriction on at least a part of execution of the functions of the mobile phone 1 that are obtained by operating the touch panel 13 (Step S404).

The controller 25 can determine whether the mobile phone 1 is in a stationary state while the voice input mode is being executed (Step S405). When it is determined that the mobile phone 1 is not in a stationary state (No at Step S405), the controller 25 can repeat the process at Step S405. When it is determined that the mobile phone 1 is in a stationary state (Yes at Step S405), the controller 25 can cancel the restriction on the operation of the touch panel 13 (Step S406).

The controller 25 can determine whether a stationary state of the mobile phone 1 has continued for a predetermined period of time after the mobile phone 1 has become stationary while the voice input mode is being executed (Step S407). When it is determined that the stationary state of the mobile phone 1 has not continued for a predetermined period of time after the mobile phone 1 has become stationary, in other words, when it is determined that the mobile phone 1 is moved once again before a predetermined period of time has passed after the mobile phone 1 has become stationary (No at Step S407), the controller 25 can set restriction on at least a part of execution of the functions of the mobile phone 1 that are obtained by operating the touch panel 13 (Step S409) once again, and return the process to Step S405. When it is determined that the stationary state of the mobile phone 1 has continued for a predetermined period of time (Yes at Step S407), the controller 25 can stop executing the voice input mode (Step S408), and finish the process.

As illustrated in FIG. 4, the controller 25 can execute the voice input mode and restrict the operation of the touch panel 13. Consequently, it is possible to further prevent the user from carefully watching the screen of the mobile phone 1, than that of the processing flow in FIG. 3.

As illustrated in FIG. 4, the mobile phone 1 notifies the user that the voice input mode is being executed. Consequently, the user can easily recognize that the voice input mode is being executed.

As illustrated in FIG. 4, when it is determined that the mobile phone 1 has become stationary, the restriction on the operation of the touch panel 13 will be canceled. Consequently, the user can operate the touch panel 13 while the mobile phone 1 is in a stationary state, whereby the operability of the mobile phone 1 during a stationary state is improved.

As illustrated in FIG. 4, the execution of the voice input mode is stopped after a predetermined period of time has passed after the mobile phone 1 has become stationary. Consequently, it is possible to reduce a possibility that the voice input mode is canceled unnecessarily.

The process of “determining whether the mobile phone 1 is being moved” at Step S401 in FIG. 4 may also be a process of “detecting whether the mobile phone 1 is being moved as well as detecting whether a predetermined operation is made on the touch panel 13”. When it is detected that the mobile phone 1 is being moved and that a predetermined operation is made on the touch panel 13, the controller 25 can execute the voice input mode. Consequently, it is possible to reduce a possibility that the voice input mode is canceled unnecessarily. The predetermined operation may be all the operations of touching the touch panel, or may be a specific touch panel operation for executing various functions.

The process of “determining whether the mobile phone 1 is being moved” at Step S401 in FIG. 4 may also be a process of “determining whether the mobile phone 1 is being moved as well as determining whether the user is holding the mobile phone 1 in his/her hand”. When it is determined that the mobile phone 1 is being moved and that the user is holding the mobile phone 1 in his/her hand, the controller 25 can execute the voice input mode. Consequently, it is possible to reduce a possibility that the voice input mode is canceled unnecessarily. In this configuration, the process of determining whether a stationary state of the mobile phone 1 has continued for a predetermined period of time after the mobile phone 1 has become stationary while the voice input mode is being executed” at Step S407 in FIG. 4 may also be a process of “determining whether a stationary state of the mobile phone 1 has continued for a predetermined period of time after the mobile phone 1 has become stationary while the voice input mode is being executed, or determining whether the mobile phone 1 is being moved but the user is not holding the mobile phone 1 in his/her hand”. When it is determined that the stationary state of the mobile phone 1 has continued for a predetermined period of time after the mobile phone 1 has become stationary, or that the mobile phone 1 is being moved but the user is not holding the mobile phone 1 in his/her hand, the controller 25 can finish executing the voice input mode.

The process of “determining whether the mobile phone 1 is being moved” at Step S401 in FIG. 4 may also be a process of “determining whether the mobile terminal 1 is being moved as well as determining whether a predetermined application is activated”. When it is determined that the mobile phone 1 is being moved and that a predetermined application is activated, the controller 25 can execute the voice input mode. Consequently, it is possible to reduce a possibility that the voice input mode is canceled unnecessarily. The predetermined application may also be activated by the voice command upon detecting the voice trigger. In this configuration, the process of “determining whether a stationary state of the mobile phone 1 has continued for a predetermined period of time after the mobile phone 1 has become stationary while the voice input mode is being executed” at Step S407 in FIG. 4 may also be a process of “determining whether a stationary state of the mobile phone 1 has continued for a predetermined period of time after the mobile phone 1 has become stationary while the voice input mode is being executed, or determining whether execution of a predetermined application has finished”. When it is determined that the stationary state of the mobile phone 1 has continued for a predetermined period of time after the mobile phone 1 has become stationary, or that the execution of a predetermined application has finished, the controller 25 can finish executing the voice input mode.

The process of “determining whether the mobile phone 1 is being moved” at Step S401 in FIG. 4 may also be a process of “determining whether the mobile phone 1 is being moved as well as determining whether a predetermined function of a predetermined application is being executed”. When it is determined that the mobile phone 1 is being moved and that a predetermined function of a predetermined application is being executed, the controller 25 can execute the voice input mode. Consequently, it is possible to reduce a possibility that the voice input mode is canceled unnecessarily. In this configuration, the process of “determining whether a stationary state of the mobile phone 1 has continued for a predetermined period of time after the mobile phone 1 has become stationary while the voice input mode is being executed” at Step S407 in FIG. 4 may also be a process of “determining whether a stationary state of the mobile phone 1 has continued for a predetermined period of time after the mobile phone 1 has become stationary while the voice input mode is being executed, or determining whether execution of a predetermined function of a predetermined application is finished”. When it is determined that the stationary state of the mobile phone 1 has continued for a predetermined period of time after the mobile phone 1 has become stationary, or that the execution of a predetermined function of a predetermined application is finished, the controller 25 can finish executing the voice input mode.

In FIG. 4, the order of Step S402 and Step S403 may be reversed.

As described above, the controller 25 can specify how the user is moving. The processing flows in FIG. 3 and FIG. 4 are executed when the user is walking, on a vehicle, or the like. The user may also selectively execute the two processes described above depending on the moving speed and/or modes of transportation. For example, when the mobile phone 1 is moving as a result of the user walking, the controller 25 may execute the processing flow in FIG. 3, and when the mobile phone 1 is moving as a result of the vehicle traveling, the controller 25 may execute the processing flow in FIG. 4. However, conditions and a method for executing a specific processing flow are not limited thereto.

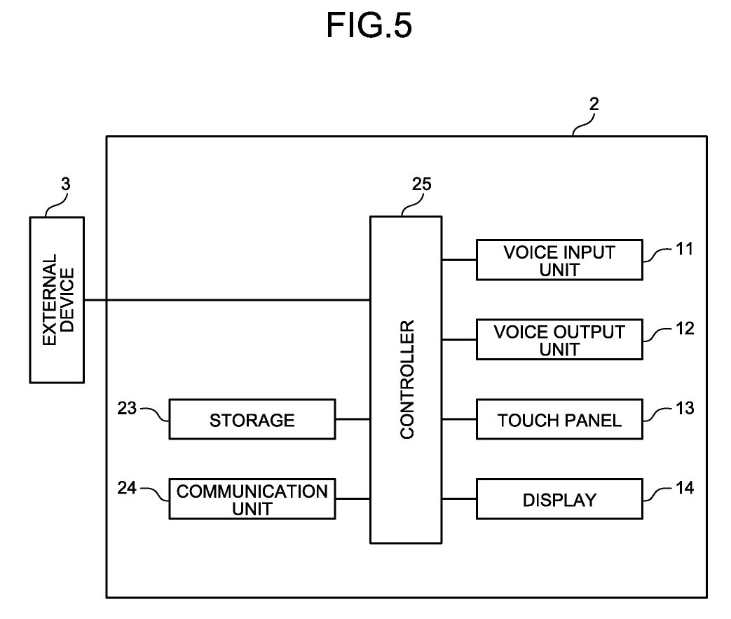

A mobile phone 2 of a second embodiment of an electronic device according to the present application will now be described. FIG. 5 is a block diagram illustrating a functional configuration of the mobile phone 2. The mobile phone 2 includes the voice input unit 11, the voice output unit 12, the touch panel 13, the display 14, the storage 23, and the controller 25.

The mobile phone 2 can be wirelessly or wiredly connected to an external device 3.

The external device 3 is an on-vehicle electronic device mounted on a vehicle. For example, the external device 3 is a car navigation device. For example, the external device 3 includes an acceleration sensor, and detects the speed of a vehicle on the basis of the detection result of the acceleration sensor.

The controller 25 can determine whether the mobile phone 2 is being moved on the basis of speed information acquired from the car navigation device that is the external device 3.

The controller 25 can execute the voice input mode when it is determined that the mobile phone 2 is being moved.

As described above, in the second embodiment, the electronic device determines whether the electronic device is being moved on the basis of information acquired from the external device 3. The processing modes relating to the execution of the voice input mode in the second embodiment may be the same as those in the first embodiment.

In the above, the electronic device according to the second embodiment is the mobile phone. However, the embodiments are not limited thereto, and the electronic device may also be the car navigation device. In this case, for example, the external device 3 is a vehicle speed sensor mounted on a vehicle. For example, the vehicle speed sensor detects the speed of the vehicle on the basis of a vehicle speed pulse signal proportional to the rotation speed of the axle.

The controller 25 can determine whether the mobile phone 2 is moving on the basis of speed information acquired from the vehicle speed sensor that is the external device 3.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electronic device, comprising:
a voice input unit; and
a controller configured to execute a voice input mode in which a process according to a voice command input to the voice input unit is performed, wherein
the controller is configured to:
determine whether the electronic device is being moved, and
execute the voice input mode when determining that the electronic device is being moved.

2. The electronic device according to claim 1, wherein the controller is configured to:
determine whether the electronic device is being moved and whether the electronic device is held in a hand of a user, and
execute the voice input mode when determining that the electronic device is being moved and that the electronic device is held in the hand of the user.

3. The electronic device according to claim 1, wherein the controller is configured to:
determine whether the electronic device is being moved and whether an application is activated, and
execute the voice input mode when determining that the electronic device is being moved and that a predetermined application is activated.

4. The electronic device according to claim 1, wherein the controller is configured to:
determine whether the electronic device is being moved and whether a predetermined function of an application is being executed, and
execute the voice input mode when determining that the electronic device is being moved and that a predetermined function of a predetermined application is being executed.

5. The electronic device according to claim 1, further comprising a touch panel, wherein
the controller is configured to:
determine whether the electronic device is being moved and whether an operation is performed on the touch panel, and
execute the voice input mode when determining that the electronic device is being moved and a predetermined operation is performed on the touch panel.

6. The electronic device according to claim 1, further comprising a touch panel, wherein
the controller is configured to start executing the voice input mode and set restriction on at least a part of execution of a plurality of functions obtained by operating the touch panel.

7. The electronic device according to claim 6, wherein the controller is configured to cancel the restriction on the execution of the functions, when determining that the electronic device is in a stationary state while the voice input mode is being executed.

8. The electronic device according to claim 1, wherein the controller is configured to stop executing the voice input mode, when determining that the electronic device is in a stationary state while the voice input mode is being executed, and that the stationary state of the electronic device has continued for a predetermined period of time.

9. The electronic device according to claim 1, wherein the controller is configured to output voice in response to input voice, as the process.

10. The electronic device according to claim 1, wherein the controller is configured to output a voice indicating that the voice input mode is being executed, when execution of the voice input mode is started.

11. A control method of an electronic device that includes a voice input unit and a controller, the controller being capable of executing a voice input mode in which a process is performed according to a voice command input to the voice input unit, the control method comprising steps of:
determining whether the electronic device is being moved; and
executing the voice input mode when determining that the electronic device is being moved.

12. A non-transitory computer readable recording medium storing thereon a control code causing an electronic device including a voice input unit and a controller, the controller being capable of executing a voice input mode for performing a process according to a voice command input to the voice input unit, to execute steps of:
determining whether the electronic device is being moved; and
executing the voice input mode when determining that the electronic device is being moved.
